(19) United States
(12) Patent Application Publication
(10) Pub. No.: US 2025/0312661 A1
(43) Pub. Date: Oct. 9, 2025

(54) Golf Club Stand Device

(71) Applicant: Ignacio Ferrer, Redlands, CA (US)

(72) Inventor: Ignacio Ferrer, Redlands, CA (US)

(21) Appl. No.: 18/629,362

(22) Filed: Apr. 8, 2024

(51) Int. Cl. A63B 55/10; F16M 13/02

(52) U.S. Cl. CPC A63B 55/10; F16M 13/02

(57) ABSTRACT

A golf club stand device for temporarily holding golf clubs over the ground at a golf course includes a stake having a bottom end that is pointed and insertable into the ground. A club mount is spaced from the bottom end of the stake by between 25.0 inches and 45.0 inches so that the club mount can suspend the golf clubs above the ground. The club mount includes a hub extending around the stake and a plurality of arms coupled to the hub. Each arm includes a base end coupled to the hub. A shaft extends from the base end. A head is coupled to the shaft distally to the base end. The head has a first edge and a second edge. The head is concavely arcuate between the first edge and the second edge wherein the head is configured to releasably retain a golf club.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stands for golf clubs and more particularly pertains to a new stand for golf clubs for temporarily holding golf clubs over the ground at a golf course.

### (2) Description of Related Art Including Information Disclosed Under 37 CFR 1.97 and 1.98

The prior art relates to stands for golf clubs. Typically, a golfer uses multiple golf clubs while golfing. Golfers often carry their golf clubs in a bag, then remove the clubs from the bag as needed at each hole. Because multiple clubs are usually needed for each hole, golfers often place clubs on the ground instead of putting the clubs back into the bag each time the golfer changes clubs. The clubs can be difficult to see when laying on the ground, resulting in the clubs being forgotten or the golfer needing to backtrack across the course to retrieve their clubs. Thus, there is a need for a device that can hold the golf clubs over the ground so that the clubs are easy to see and less likely to be forgotten. Ideally, such a device would be lightweight and easy to carry in the bag with the clubs as the golfer moves between holes.

### BRIEF SUMMARY OF THE INVENTION

An embodiment of the disclosure meets the needs presented above by generally comprising a stake having a bottom end. The bottom end is pointed wherein the bottom end is configured to be insertable into a ground surface. A club mount is coupled to the stake. The club mount is spaced from the bottom end of the stake by between 25.0 inches and 45.0 inches wherein the club mount is configured to suspend a plurality of golf clubs above the ground surface when the bottom end of the stake is inserted into the ground surface. The club mount includes a hub extending around the stake and a plurality of arms that is coupled to the hub. Each arm of the plurality of arms is spaced from an adjacent arm of the plurality of arms. Each arm of the plurality of arms includes a base end that is coupled to the hub. A shaft extends from the base end. A head is coupled to the shaft distally to the base end. The head has a first edge and a second edge. The head is concavely arcuate between the first edge and the second edge wherein the head is configured to releasably retain a golf club of the plurality of golf clubs.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top front isometric view of a golf club stand device according to an embodiment of the disclosure.

FIG. 2 is a side view of an embodiment of the disclosure.

FIG. 3 is a top view of an embodiment of the disclosure.

FIG. 4 is a front view of an embodiment of the disclosure.

FIG. 5 is a perspective view of an embodiment of the disclosure.

FIG. 6 is an in-use view of an embodiment of the disclosure.

### DETAILED DESCRIPTION OF THE INVENTION

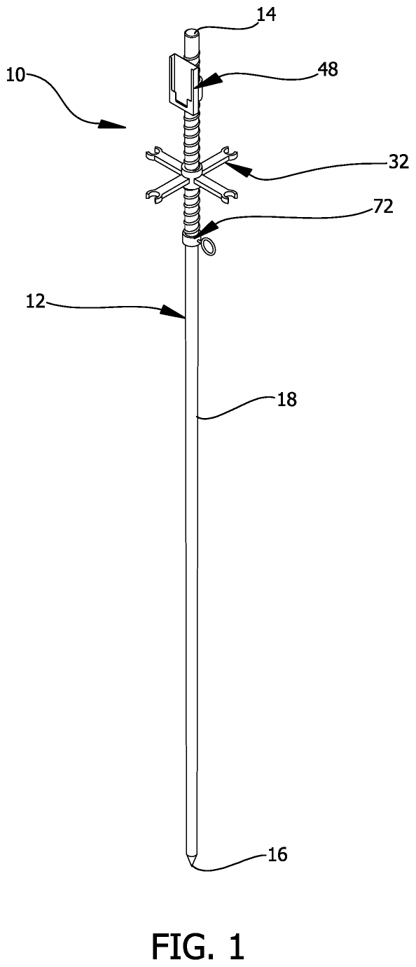

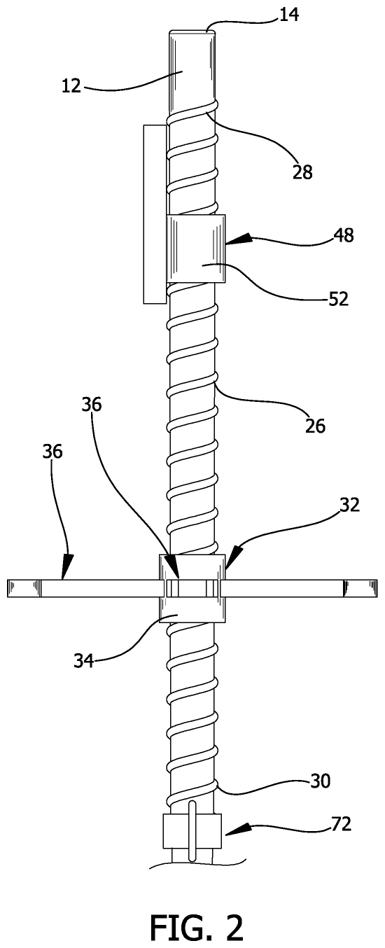

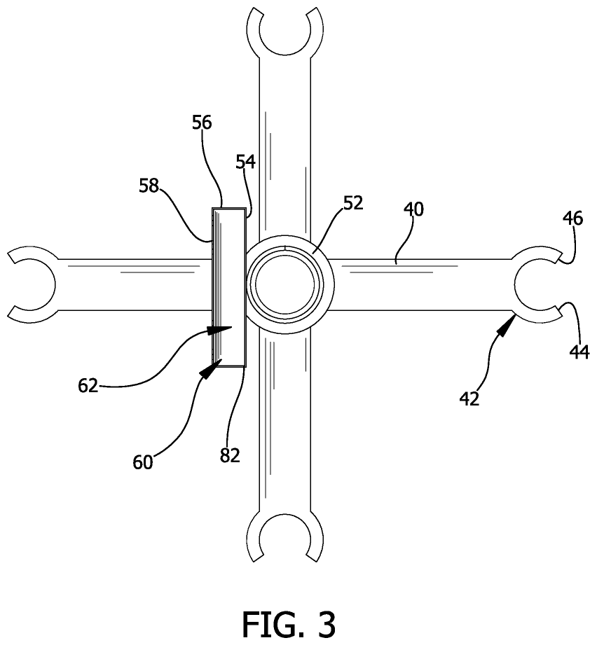

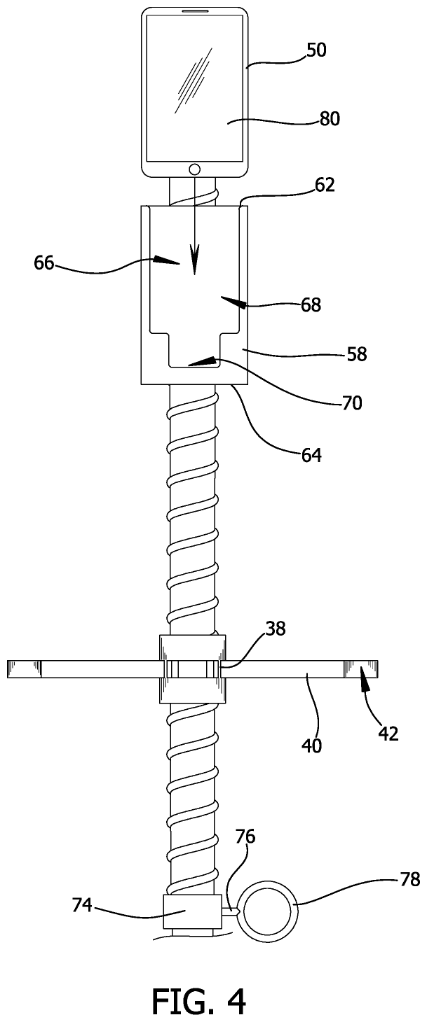

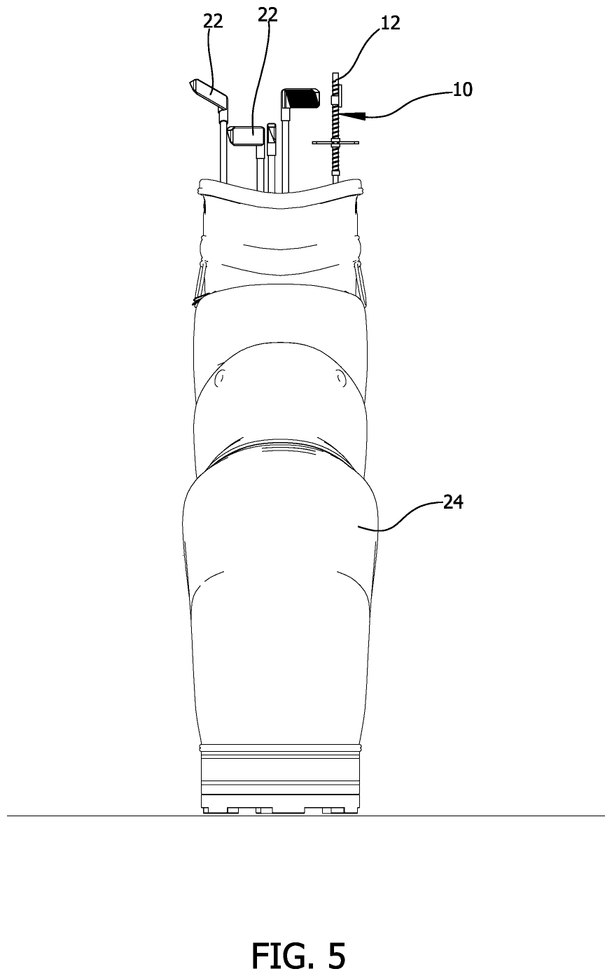

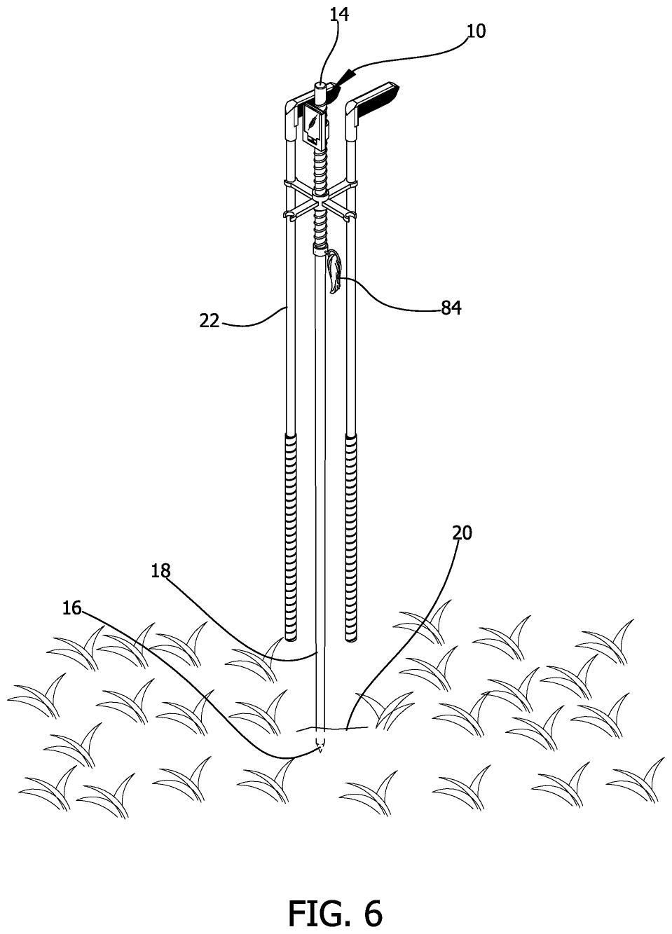

With reference now to the drawings, and in particular to FIGS. 1 through 6 thereof, a new stand for golf clubs embodying the principles and concepts of an embodiment of the disclosure and generally designated by the reference numeral 10 will be described.

As best illustrated in FIGS. 1 through 6, the golf club stand device 10 generally comprises a stake 12 having a top end 14, a bottom end 16, and an elongated body 18 that is coupled to and extends between the top end 14 and the bottom end 16. The bottom end 16 is pointed wherein the bottom end 16 is configured to be insertable into a ground surface 20. The stake 12 may be rounded wherein the top end 14 is circular. The stake 12 may have a height between 30.0 inches and 50.0 inches wherein the stake 12 is configured to hold a plurality of golf clubs 22 above the ground surface 20 when the bottom end 16 is inserted into the ground surface 20. The stake 12 may comprise a fiberglass material wherein the stake 12 is configured to be lightweight and wherein the stake 12 is configured to be easily carried in a golf bag 24 with the plurality of golf clubs 22.

A grip 26 may be coupled to the stake 12. The grip 26 may have an upper side 28 and a lower side 30. The upper side 28 of the grip 26 is generally positioned proximate to the top end 14 of the stake 12. The grip 26 generally extends downwardly along the elongated body 18 toward the bottom end 16 of the stake 12. The lower side 30 of the grip 26 may be spaced from the bottom end 16 of the stake 12. The grip 26 may comprise a rubber material wherein the grip 26 is configured to facilitate the user in gripping the stake 12, inserting the stake 12 into the ground surface 20, and removing the stake 12 from the ground surface 20.

A club mount 32 is coupled to the stake 12. In some embodiments, the club mount 32 may be coupled to the grip 26. The club mount 32 is generally positioned proximate to the top end 14 of the stake 12. The club mount 32 extends outwardly from the stake 12 wherein the club mount 32 is configured to releasably retain the plurality of golf clubs 22. The club mount 32 may be spaced from the bottom end 16 of the stake 12 by between 25.0 inches and 45.0 inches wherein the club mount 32 is configured to suspend the plurality of golf clubs 22 above the ground surface 20 when the bottom end 16 of the stake 12 is inserted into the ground surface 20.

The club mount 32 may include a hub 34 extending around the stake 12, or the grip 26, to couple the club mount 32 to the stake 12, or the grip 26. The hub 34 is generally hollow wherein the grip 26 and the stake 12 are positionable within the hub 34. The hub 34 may be cylindrical.

A plurality of arms 36 is coupled to the hub 34. The plurality of arms 36 extends outwardly from the hub 34. For example, the plurality of arms 36 may extend radially from the stake 12. The plurality of arms 36 may be perpendicular to the hub 34. The plurality of arms 36 may be perpendicular to the stake 12. The plurality of arms 36 may be centrally positioned along a length of the hub 34. Each arm of the plurality of arms 36 is generally spaced from an adjacent arm of the plurality of arms 36. Each arm of the plurality of arms 36 may be perpendicular to the adjacent arm of the plurality of arms 36. Each arm of the plurality of arms 36 may be coplanar with the adjacent arm of the plurality of arms 36.

Each arm of the plurality of arms 36 may include a base end 38 that is coupled to the hub 34. A shaft 40 may extend from the base end 38. The shaft 40 generally extends outwardly from the stake 12. A head 42 may be coupled to the shaft 40 distally to the base end 38. The head 42 generally includes a first edge 44 and a second edge 46. The head 42 may be concavely arcuate between the first edge 44 and the second edge 46 wherein the head 42 is configured to releasably retain a golf club of the plurality of golf clubs 22.

A phone mount 48 may be coupled to the stake 12. In other embodiments, the phone mount 48 may be coupled to the grip 26. The phone mount 48 may be positioned proximate to the upper side 28 of the grip 26. For example, the phone mount 48 may be positioned between the top end 14 of the stake 12 and the club mount 32. The phone mount 48 is generally configured to releasably retain a mobile device 50 of a user. For example, the mobile device 50 may be a cell phone or a tablet.

The phone mount 48 may include a sleeve 52 that extends around the stake 12 or the grip 26 to couple the phone mount 48 to the stake 12 or the grip 26. The sleeve 52 is generally hollow wherein the grip 26 and the stake 12 are positionable within the sleeve 52. The sleeve 52 may be cylindrical.

A rear panel 54 may be coupled to the sleeve 52. The rear panel 54 may be rectangular. The rear panel 54 may be planar.

A peripheral wall 56 may be coupled to and extend outwardly from the rear panel 54. The peripheral wall 56 may extend along a peripheral edge 82 of the rear panel 54. The peripheral wall 56 may be perpendicular to the rear panel 54.

A front panel 58 may be coupled to and extend from the peripheral wall 56 such that the rear panel 54, the peripheral wall 56, and the front panel 58 define a cradle 60 that is configured to retain the mobile device 50. The front panel 58 may extend perpendicularly from the peripheral wall 56. The front panel 58 may be parallel to the rear panel 54. The front panel 58 may be distally positioned on the peripheral wall 56 relative to the rear panel 54. In other words, the front panel 58 is generally spaced from the rear panel 54 by the peripheral wall 56.

The cradle 60 may have an open top side 62 that is configured to receive the mobile device 50. The mobile device 50 may be positionable within the cradle 60 through the open top side 62. The cradle 60 generally has a closed bottom side 64 that is configured to support the mobile device 50 when the mobile device 50 is positioned within the phone mount 48. The mobile device 50 rests on the closed bottom side 64 when the mobile device 50 is positioned within the cradle 60. The sleeve 52 may be positioned on the rear panel 54 proximate to the closed bottom side 64 of the cradle 60.

A cutout 66 may extend through the front panel 58 wherein the cutout 66 is configured to align with a display screen 80 of the mobile device 50 when the mobile device 50 is positioned in the cradle 60. The cutout 66 is configured to expose the display screen 80 of the mobile device 50 when the mobile device 50 is positioned in the cradle 60. Generally, the cutout 66 is also configured to expose a front camera of the mobile device 50 when the mobile device 50 is positioned in the cradle 60, such that the user can view the display screen 80 and film with the front camera while the mobile device 50 is being held by the phone mount 48.

The cutout 66 may further include an upper portion 68 extending downwardly from the open top side 62 of the cradle 60. A lower portion 70 may extend downwardly from the upper portion 68. The lower portion 70 may have a width that is less than a width of the upper portion 68. The lower portion 70 is generally spaced from the closed bottom side 64 of the cradle 60.

A hanger 72 may be coupled to the stake 12, or the grip 26. The hanger 72 may be positioned on the lower side 30 of the grip 26, or on the elongated body 18 of the stake 12. For example, the hanger 723 may be positioned beneath the club mount 32. The hanger 72 generally extends outwardly from the stake 12 wherein the hanger 72 is configured to releasably retain a cloth 84. For example, the cloth 84 may comprising one of a towel, a washcloth, a glove, a jacket, or a headband. The cloth 84 may also comprise other items, and the preceding list is intended as illustrative and is not contemplated to be exhaustive.

The hanger 72 may include a band 74 that extends around the stake 12 or the grip 26 to couple the hanger 72 to the stake 12 or the grip 26. The band 74 is generally hollow wherein the grip 26 and the stake 12 are positionable within the band 74. The band 74 may be cylindrical.

A post 76 may extend outwardly from the band 74. The post 76 may be perpendicular to the band 74. The post 76 may be parallel to the plurality of arms 36 of the club mount 32.

A hoop 78 may be coupled to the post 76 distally to the band 74. The hoop 78 is generally hollow wherein the hoop 78 is configured to receive the cloth 84. The hoop 78 may be perpendicular to the band 74. The post 76 may have a length that is shorter than a length of the plurality of arms 36 wherein the hoop 78 is positioned closer to the stake 12 than the head 42 of each arm of the plurality of arms 36.

In use, a golf club of the plurality of golf clubs 22 may be placed in the head 42 of each arm of the plurality of arms 36. The golf club is suspended over the ground surface 20 and is visible to the user to inhibit the user from forgetting to retrieve the golf club before moving to the next hole. When the user moves to another hole, the user can remove the golf club from the arm of the club mount 32 and place the golf club in the golf bag 24. Because the stake 12 is elongated and lightweight, the stake 12 can also be placed in the golf bag 24 and carried with the plurality of golf clubs 22 to the next hole. The cloth 84 may be held on the stake 12 with the hanger 72, so that the cloth 84 is easily accessible for the user.

The mobile device 50 may be positioned in the cradle 60 of the phone mount 48. Generally, the camera of the mobile device 50 will be exposed, and the display screen 80 may also be exposed. The user can hold the mobile device 50 in the phone mount 48 so that the user does not need to hold the mobile device 50 on their person. With the display screen 80 and front camera exposed, the user can also film their golf swings and golf game while the mobile device 50 is held in the cradle 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A golf club support apparatus comprising:
a stake having a bottom end, the bottom end being pointed wherein the bottom end is configured to be insertable into a ground surface;
a club mount being coupled to the stake, the club mount being spaced from the bottom end of the stake by between 25.0 inches and 45.0 inches wherein the club mount is configured to suspend a plurality of golf clubs above the ground surface when the bottom end of the stake is inserted into the ground surface, the club mount including:
a hub extending around the stake;
a plurality of arms being coupled to the hub, each arm of the plurality of arms being spaced from an adjacent arm of the plurality of arms, each arm of the plurality of arms including:
a base end being coupled to the hub;
a shaft extending from the base end; and
a head being coupled to the shaft distally to the base end, the head having a first edge and a second edge, the head being concavely arcuate between the first edge and the second edge wherein the head is configured to releasably retain a golf club of the plurality of golf clubs.

2. The golf club support apparatus of claim 1, further comprising a phone mount being coupled to the stake, the phone mount being positioned proximate to a top end of the stake, the phone mount being configured to releasably retain a mobile device of a user.

3. The golf club support apparatus of claim 2, the phone mount further comprising:
a sleeve extending around the stake;
a rear panel being coupled to the sleeve;
a peripheral wall being coupled to and extending outwardly from the rear panel; and
a front panel being coupled to and extending from the peripheral wall such that the rear panel, the peripheral wall, and the front panel define a cradle being configured to retain the mobile device.

4. The golf club support apparatus of claim 3, wherein the front panel is parallel to the rear panel.

5. The golf club support apparatus of claim 3, wherein the peripheral wall is perpendicular to the rear panel.

6. The golf club support apparatus of claim 3, the cradle further comprising:
an open top side being configured to receive the mobile device; and
a closed bottom side being configured to support the mobile device when the mobile device is positioned within the phone mount.

7. The golf club support apparatus of claim 3, further comprising a cutout extending through the front panel wherein the cutout is configured to align with a display screen of the mobile device when the mobile device is positioned in the cradle whereby the cutout is configured to expose the display screen of the mobile device when the mobile device is positioned in the cradle.

8. The golf club support apparatus of claim 7, the cutout further comprising:
an upper portion extending downwardly from an open top side of the cradle; and
a lower portion extending downwardly from the upper portion, the lower portion having a width being less than a width of the upper portion, the lower portion being spaced from a closed bottom side of the cradle.

9. The golf club support apparatus of claim 1, further comprising a hanger being coupled to the stake, the hanger extending outwardly from the stake wherein the hanger is configured to releasably retain a cloth.

10. The golf club support apparatus of claim 9, the hanger further comprising:
a band extending around the stake;
a post extending from the band; and
a hoop being coupled to the post distally to the band, the hoop being hollow wherein the hoop is configured to receive the cloth.

11. The golf club support apparatus of claim 10, wherein the post has a length being shorter than a length of the plurality of arms of the club mount wherein the hoop is positioned closer to the stake than the head of each arm of the plurality of arms.

12. The golf club support apparatus of claim 10, wherein the post is parallel to the plurality of arms of the club mount.

13. The golf club support apparatus of claim 1, wherein each arm of the plurality of arms extends outwardly from the hub wherein the plurality of arms extends radially from the stake.

14. The golf club support apparatus of claim 1, wherein each arm of the plurality of arms is perpendicular to an adjacent arm of the plurality of arms.

15. The golf club support apparatus of claim 1, wherein each arm of the plurality of arms is coplanar with an adjacent arm of the plurality of arms.

16. A golf club support apparatus comprising:
a stake having a top end, a bottom end, and an elongated body being coupled to and extending between the top end and the bottom end, the bottom end being pointed wherein the bottom end is configured to be insertable into a ground surface, the stake being rounded wherein the top end is circular, the stake having a height between 30.0 inches and 50.0 inches wherein the stake is configured to hold a plurality of golf clubs above the ground surface when the bottom end is inserted into the ground surface, the stake comprising a fiberglass material wherein the stake is configured to be lightweight;
a grip being coupled to the stake, the grip having an upper side and a lower side, the upper side of the grip being positioned proximate to the top end, the grip extending downwardly along the elongated body toward the bottom end, the lower side of the grip being spaced from the bottom end of the stake, the grip comprising a rubber material;
a club mount being coupled to the grip, the club mount being positioned proximate to the top end of the stake, the club mount extending outwardly from the stake wherein the club mount is configured to releasably retain the plurality of golf clubs, the club mount being spaced from the bottom end of the stake by between 25.0 inches and 45.0 inches wherein the club mount is configured to suspend the plurality of golf clubs above the ground surface when the bottom end of the stake is inserted into the ground surface, the club mount including:
a hub extending around the grip to couple the club mount to the grip, the hub being hollow wherein the grip and the stake are positionable within the hub, the hub being cylindrical;
a plurality of arms being coupled to the hub, the plurality of arms extending outwardly from the hub wherein the plurality of arms extends radially from the stake, the plurality of arms being perpendicular to the hub wherein the plurality of arms is perpendicular to the stake, the plurality of arms being centrally positioned along a length of the hub, each arm of the plurality of arms being spaced from an adjacent arm of the plurality of arms, each arm of the plurality of arms being perpendicular to the adjacent arm of the plurality of arms, each arm of the plurality of arms being coplanar with the adjacent arm of the plurality of arms, each arm of the plurality of arms including:
a base end being coupled to the hub;
a shaft extending from the base end, the shaft extending outwardly from the stake;
a head being coupled to the shaft distally to the base end, the head having a first edge and a second edge, the head being concavely arcuate between the first edge and the second edge wherein the head is configured to releasably retain a golf club of the plurality of golf clubs;
a phone mount being coupled to the grip, the phone mount being positioned proximate to the upper side of the grip, the phone mount being positioned between the top end of the stake and the club mount, the phone mount being configured to releasably retain a mobile device of a user, the phone mount including:
a sleeve extending around the grip to couple the phone mount to the grip, the sleeve being cylindrical, the sleeve being hollow wherein the grip and the stake are positionable within the sleeve;
a rear panel being coupled to the sleeve, the rear panel being rectangular, the rear panel being planar;
a peripheral wall being coupled to and extending outwardly from the rear panel, the peripheral wall extending along a peripheral edge of the rear panel, the peripheral wall being perpendicular to the rear panel;
a front panel being coupled to and extending from the peripheral wall such that the rear panel, the peripheral wall, and the front panel define a cradle being configured to retain the mobile device, the front panel extending perpendicularly from the peripheral wall, the front panel being parallel to the rear panel, the front panel being distally positioned on the peripheral wall relative to the rear panel;
the cradle having an open top side being configured to receive the mobile device, the cradle having a closed bottom side being configured to support the mobile device when the mobile device is positioned within the phone mount, the sleeve being positioned on the rear panel proximate to the closed bottom side of the cradle;
a cutout extending through the front panel wherein the cutout is configured to align with a display screen of the mobile device when the mobile device is positioned in the cradle whereby the cutout is configured to expose the display screen of the mobile device when the mobile device is positioned in the cradle, the cutout further including:
an upper portion extending downwardly from the open top side of the cradle;
a lower portion extending downwardly from the upper portion, the lower portion having a width being less than a width of the upper portion, the lower portion being spaced from the closed bottom side of the cradle;
a hanger being coupled to the grip, the hanger being positioned on the lower side of the grip, the hanger extending outwardly from the stake wherein the hanger is configured to releasably retain a cloth, the hanger including:
a band extending around the grip to couple the hanger to the grip, the band being hollow wherein the grip and the stake are positionable within the band, the band being cylindrical;
a post extending outwardly from the band, the post being perpendicular to the band, the post being parallel to the plurality of arms of the club mount;
a hoop being coupled to the post distally to the band, the hoop being hollow wherein the hoop is configured to receive the cloth, the hoop being perpendicular to the band; and
the post having a length being shorter than a length of the plurality of arms wherein the hoop is positioned closer to the stake than the head of each arm of the plurality of arms.
